(19) United States
(12) Patent Application Publication
(10) Pub. No.: US 2024/0057498 A1
(43) Pub. Date: Feb. 22, 2024

(54) PRE-LOAD ATTACHMENT BRACKET FOR DOWN-FORCE AND LIFT ON PLANTER CLOSING SYSTEM

(71) Applicant: SCHAFFERT MANUFACTURING COMPANY, INC., Indianola, NE (US)

(72) Inventors: Paul E. SCHAFFERT, Indianola, NE (US); Kris SCHAFFERT, Indianola, NE (US)

(21) Appl. No.: 18/235,053

(22) Filed: Aug. 17, 2023

Related U.S. Application Data
(60) Provisional application No. 63/398,663, filed on Aug. 17, 2022.

(51) Int. Cl. A01B 63/00; A01C 5/06

(52) U.S. Cl. CPC A01B 63/008; A01C 5/068

(57) ABSTRACT

An assembly for an agricultural planter includes a mounting bracket configured for attachment to a frame of the agricultural planter. The assembly further includes an implements frame configured for mounting rotatable implements of the agricultural planter. The assembly further includes a parallel linkage pivotally connecting the mounting bracket to the implements frame. The assembly further includes biasing device having a first end and a second end. The first end is associated with the mounting bracket, and the second end is associated with the parallel linkage such that the biasing device selectively loads the rotatable implements with a threshold load. The biasing device is configured to manipulate the parallel linkage and load the rotatable implements with additional load in excess of the threshold load.

### CROSS-REFERENCE TO RELATED APPLICATIONS

This application claims the benefit of priority pursuant to 35 U.S.C. § 119(e) of U.S. Provisional Patent Application No. 63/398,663, filed Aug. 17, 2022, titled “Pre-Load Attachment Bracket for Down-Force and Lift on Planter Closing System,” which is hereby incorporated by reference herein in its entirety.

### FIELD

The disclosed technology relates to agricultural seed planters and, in particular, to furrow closing systems.

### BACKGROUND

Agricultural seed planting is typically accomplished by multi-row planters. Each planter may include multiple row units adapted for opening a seed furrow, depositing seeds within the furrow, and closing the seed furrow around the seeds.

Some planters are equipped or retrofitted to be equipped with fertilizer depositing equipment (e.g., fertilizer furrow opener discs and fertilizer deposit tubes) located on a leading or front side of the planter. Planters so configured can have problems in fields with moist or wet soil. Specifically, disturbing the soil with the fertilizer equipment located in front of the planter gauge wheels can cause the moist or wet soil to accumulate on the gauge wheels. The soil accumulation increases the effective diameters of the gauge wheels and causes the planter to run too shallow with respect to the depositing of the seed in the seed furrows.

Planters are increasingly used in no-till situations, resulting in the planter traversing fields with substantial deviation in the field surface and a substantial amount of obstructions (e.g., debris, clods, stubble, old furrows, etc.). Furthermore, in certain Midwest farm areas, ditches must be plowed in fields between planting seasons to facilitate the drainage of spring showers from the fields. Most planters have proven ineffective in such rough field surface conditions. It is not unusual for the use of planters in rough field conditions to result in seed depths that radically range between too deep and too shallow. Also, it is not unusual for the use of planters in such field conditions to result in the planter components being damaged.

Traditional closing assemblies use standard swing arm tail sections, which can be found on many of the planters built today. But, these swing arm tail sections have a limited amount of travel up and down (roughly 4″) throughout full movement when planting. These tail sections are limited when there are ditches to cross or terraces to plant over, as the amount of travel is limited to 2″ both ways of center. Sometimes this isn't enough as it gives poor seed to soil contact by not closing the seed V properly or leaving seeds on top of the ground. Whenever the press wheels flex up the contact points on the press wheels get wider causing them to be toe out and they tend to over cover the width of the seed V. When the press wheels go down past center they under cover resulting in toe in, which causes the seed V to not close properly. Also when the wheels max out, the wheels on the top side can raise the planter unit out of the ground causing seed depth to change. By running extra spring pressure on the press wheels you create up pressure on the row units. Thus, swing arm tail sections have severe limitations.

Furthermore, as the planter travels through the field at speeds above 5 MPH, the swing arm closing systems are constantly moving or vibrating up and down along the planter unit itself causing uneven depth control. Also when planting up and over terraces, there are areas over the top of the terrace that cause the double discs of the planter to lift out of the ground, thereby planting the seeds on top of the ground. In some instances the press wheels to carry the weight of whole planter on one side or other of the terrace, and then on the opposite side of the terrace, the double discs openers bottom out for depth and the press wheels are lifted off the ground and are unable to close the furrow. This leaves several feet of seeded area across a ditch or terrace that is blanked out due to poor seed to soil contact.

A press wheel or firmer wheel is a wheel attachment on an agricultural unit for compacting the soil in the seeded furrows after the soil has been planted and, in some instances, after a closing wheel has deposited loose soil overtop of the seed. Traditional press wheels compress and mold the bottom of the furrow to establish an environment conducive to good germination. Seed germination is promoted through soil compaction by minimizing air pockets, thus improving the capillary action of the moisture in the soil as well as reducing wind erosion of the soil over the seed.

The information included in this Background section of the specification, including any references cited herein and any description or discussion thereof, is included for technical reference purposes only and is not to be regarded subject matter by which the scope of the invention as defined in the claims is to be bound.

### SUMMARY

A typical agriculture planter may include a planter frame, a seed hopper, and a trailing arm assembly. The planter frame may include a hitch tongue extending forward from the planter frame for attachment to a tractor that pulls the planter. The trailing arm assembly may be coupled to a rear portion of the planter frame via a parallel linkage and extend rearward from the planter frame, and include separate, but adjustable, trailing arm assemblies for the opening implements and the closing implements.

A furrow closing assembly for the agricultural planter may include a mounting bracket configured for attachment to a furrow opener assembly of the agricultural planter. A rigid frame forming part of the furrow closing assembly may be configured for mounting furrow closing components thereon. A parallel linkage pivotably connects the mounting bracket to the rigid frame with a first pivot bearing connecting the mounting bracket to the parallel linkage and a second pivot bearing connecting the parallel linkage to the rigid frame. A biasing device may be fixed at a first end to the rigid frame and attached at a second end to the parallel linkage.

In any embodiment, the furrow closing assembly may include a torsion axle fixed to the parallel linkage. A shaft of the biasing device may be pivotably attached to the torsion axle. In an exemplary implementation, the torsion axle may be formed by extending an elongated block or tube of square cross section between and fixedly attaching it at each end to opposite bars of the parallel linkage. A square tube of larger perimeter dimension than the elongated block or tube may be placed concentrically about the elongated block or tube. A plurality of dense elastomeric members may be positioned between exterior walls of the elongated block or tube and interior walls of the square tube.

Also, in any embodiment, a load cell may be mounted between a first end of the biasing device and the rigid frame.

In another implementation, a method of operating a furrow closer assembly having a parallel linkage attached between a furrow opener assembly and a frame of the furrow closer assembly and a biasing device fixedly mounted to the frame and pivotably mounted to the parallel linkage may include the following steps. The biasing device may be actuated to extend a shaft of the biasing device. A downward force is provided on the furrow closer assembly by extension of the shaft.

In another implementation, a furrow closing assembly for an agricultural planter is disclosed. The furrow closing assembly includes a mounting bracket configured for attachment to a furrow opener assembly of the agricultural planter. The furrow closing assembly further includes a rigid frame configured for mounting furrow closing components thereon. A furrow closing assembly further includes a parallel linkage pivotably connecting the mounting bracket to the rigid frame with a first pivot bearing connecting the mounting bracket to the parallel linkage and a second pivot bearing connecting the parallel linkage to the rigid frame. The furrow closing assembly further includes a torsion axle fixed to the parallel linkage. The furrow closing assembly further includes a biasing device fixed at a first end to the rigid frame and pivotally attached to the torsion axle.

In another implementation, the torsion axle may be configured to allow travel between the biasing device and the parallel linkage. The travel may be constrained by a plurality of torsion bumpers integrated with the torsion axle. The plurality of torsion bumpers may include a plurality of dense elastomeric members configured to compress with movement of the biasing device relative to the parallel linkage.

In another implementation, the torsion axle may further include a torsion block fixedly attached to the parallel linkage. The plurality of torsion bumpers may be arranged about the torsion block. The torsion axle may further include a case wrapped around the plurality of torsion bumpers and the torsion block. In this regard, the torsion block may further include a coupled plate extending from the case. The actuator may be pivotally attached to the torsion axle at the coupler plate. In some cases, a shaft of the actuator may be engaged in double shear with the coupler plate.

In another implementation, the actuator includes a linear screw actuator. The linear screw actuator may include an electromechanical device with a screw drive. The linear screw actuator may be configured to provide static resistance to external forces received by the parallel linkage.

In another implementation, an assembly for an agricultural planter is disclosed. The assembly includes a mounting bracket configured for attachment to a furrow opener assembly of the agricultural planter. The assembly further includes an implements frame configured for mounting rotatable implements of the agricultural planter. The assembly further includes a parallel linkage pivotally connecting the mounting bracket to the implements frame. The assembly further includes a biasing device having a first end and a second end. The first end is associated with the mounting bracket. The second end is associated with the parallel linkage such that the biasing device loads the rotatable implements with a threshold load. The biasing device may be configured to manipulate the parallel linkage and load the rotatable implements with additional load in excess of the threshold load.

In another implementation, the assembly may further include a coupling assembly connecting the second end of the biasing device to the parallel linkage. The coupling assembly may be configured to selectively define a position of the second end of the biasing device relative to the parallel linkage. In this regard, in a first configuration, the coupling assembly may be configured to define a first position of the second end of the biasing device relative to the parallel linkage. Further, the first position of the second end of the biasing device relative to the parallel linkage may establish the threshold load as having a first value. In this regard, in a second configuration, the coupling assembly may be configured to define the second position of the second end of the biasing device relative to the parallel linkage. Further, the second position of the second end of the biasing device relative to the parallel linkage may establish the threshold load as having a second value that is different than the first value.

In another implementation, the biasing device includes a linear screw actuator having a shaft. In another implementation, the biasing device includes a pneumatic or hydraulic cylinder assembly having a shaft or cylinder extending from another cylinder. The shaft may be associated with one of the first end or the second end. The shaft may be extendable to cause the biasing device to load the rotatable implements with additional load in excess of the threshold load.

In another implementation, the coupling assembly may further include a torsion axle. The shaft may be associated with the second end at pivotally attached to the torsion axle. The coupling assembly may be configured to selectively define a rotational position of the torsion axle relative to the parallel linkage, thereby selectively defining a position of the second end of the biasing device relative to the parallel linkage. In some cases, the coupling assembly may further include a locator assembly fixed to the torsion axle and having a locator pin. The locator pin may be manipulatable between an extended position and a retracted position. In the extended position, the locator pin may be engaged with the parallel linkage and restrain rotation of the torsion axle relative to the parallel linkage. In the retracted position, the locator pin may be disengaged with the parallel linkage and permit rotation of the torsion axle relative to the parallel linkage.

In another implementation, the parallel linkage includes a four bar linkage. Two upper bars of the four bar linkage may be both attached to a first pivot bearing at first ends and are both attached to a second pivot bearing at second ends. Further, two lower bars of the four bar linkage may be both attached to the mounting bracket at a third pivot bearing at first ends and are both attached to the rigid frame at a fourth pivot bearing at second ends. In some cases, the two upper bars may be positioned parallel to each other and are laterally separated from each other. Further, the two lower bars may be vertically separated from the two upper bars, are positioned parallel to each other, and are laterally separated from each other.

In another implementation, the assembly may further include a load cell mounted between the first end of the actuator and the implements frame. The load cell may be configured to detect a force between the rotatable implements and a ground surface. The biasing device may be configured to modify the additional load based on a detection of the force deviating from a target load.

In another implementation an assembly for an agricultural planter is disclosed. The assembly includes a mounting bracket configured for attachment to a frame of the agricultural planter. The assembly further includes an implements frame configured for mounting rotatable implements of the agricultural planter. The assembly further includes a parallel linkage pivotally connecting the mounting bracket to the implements frame. The parallel linkage may include an upper bar having a mounting region with a plurality of engagement features. The assembly may further include a biasing device having a first end and a second end, the first end associated with the mounting bracket, and the second end associated with an engagement feature of the plurality of engagement features.

In another implementation, the upper bar may further include a bar region extending integrally from the mounting region and pivotally connecting the mounting bracket to the implements frame with a first pivot bearing connecting the mounting bracket to the bar region and a second pivot bearing connecting the bar region to the implements frame. In some cases, the bar region and the mounting region may be regions of a common plate.

In another implementation, the assembly may further include a coupling assembly connecting the second end of the biasing device to the parallel linkage. The coupling assembly may be configured to selectively define a position of the second end of the biasing device relative to one or more of the engagement features. Further, the biasing device may be configured to load the rotatable implements with a first threshold load when the coupling assembly selectively defines the position of the second end of the biasing device relative to the engagement feature. And in turn, the actuator may also be configured to load the rotatable implements with a second threshold load when the coupling assembly selectively defines the position of the second end of the biasing device relative to a second engagement feature of the plurality of engagement features.

In another implementation, the biasing device may include a linear screw actuator or a pneumatic or hydraulic cylinder assembly configured to manipulate the parallel linkage and load the rotatable implements with additional load in excess of the first or second threshold loads.

In another implementation, the mounting region may be defined by a portion of a metal plate. The plurality of engagement features may include a plurality of holes extending through the portion of the metal plate. The coupling assembly may include a locator assembly configured to selectively engage holes of the plurality of holes such that the locator assembly selectively defines the position of the second end of the biasing device relative to the parallel linkage. In some cases, the coupling assembly may further include a torsion axle rotatably coupled to and extending through the metal plate, the second end of the biasing device pivotally coupled to the torsion axle. Further, the locator assembly may be fixed to the torsion axle and comprises a spring-biased locator pin configured for selective receipt into the holes of the plurality of holes.

In another implementation, a method of operating a planter assembly is disclosed. The assembly comprising a parallel linkage attached between rotatable implements and a frame of the agricultural planter, and a biasing device fixedly mounted to the frame and pivotably mounted to the parallel linkage. The method includes loading the rotatable implements of the assembly with a threshold load by selectively setting a position of the biasing device relative to the parallel linkage. The method further includes loading the rotatable implements t of the assembly with additional load in excess of the threshold load by actuating the biasing device and extending a shaft of the biasing device.

In another implementation, the position may be a first position and the threshold load may be a first threshold load. The method may further include loading the rotatable implements of the assembly with a second threshold load by selectively setting a second position of the biasing device relative to the parallel linkage. The additional load may be in excess of the first and second threshold loads. Further, loading the rotatable implements of the assembly with the threshold load may further include operating a locator pin to selectively set the position of the biasing device relative to the parallel linkage.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

The disclosure will be readily understood by the following detailed description in conjunction with the accompanying drawings, wherein like reference numerals designate like structural elements.

FIG. 1 is a side elevation view of an agriculture tractor pulling an agriculture planter.

FIG. 2 is a top-rear isometric view of the planter.

FIG. 3 is a top-rear isometric view of a prior art trailing arm assembly forming part of the planter.

FIG. 4 is a side elevation view of the trailing arm assembly of FIG. 3.

FIG. 5A is a top, side, perspective view of an embodiment of a furrow closer assembly with a four bar linkage connected to a linear actuator in a fully lifted position.

FIG. 5B is a top, side, perspective view of a furrow closer assembly with a four bar linkage connected to a linear actuator in a fully extended position.

FIG. 6A is a side elevation view of an embodiment of a four bar linkage with a biasing device mounted thereon for incorporation in to a trailing arm assembly.

FIG. 6B is a side elevation view of an embodiment of a four bar linkage with a biasing device mounted thereon for incorporation in to a trailing arm assembly.

FIG. 6C is top, rear, perspective view of the four bar linkage with a biasing device.

FIG. 6D is rear perspective view of the four bar linkage with the biasing device of FIG. 6C.

FIG. 6E is a partial rear, side, perspective view of the four bar linkage with the biasing device of FIG. 6C detailing a torsion axle mounted to the four bar linkage.

FIG. 7A is a top, front, perspective view of a torsion axle mounted to another embodiment of a four bar linkage of a furrow closer assembly.

FIG. 7B is a top, rear, perspective view of the torsion axle of FIG. 7A.

FIG. 7C is a top, side, perspective view of the torsion axle of FIG. 7A.

FIG. 8 is a schematic, cross-section view of an embodiment of a torsion axle for connection to a biasing device in any embodiment of a four bar linkage of a furrow closer assembly.

FIG. 9 is a cross-section view of the torsion axle of FIG. 6C, taken along line I-I of FIG. 6C.

FIG. 10A is a cross-section view of the torsion axle of FIG. 6C in a first configuration, taken along line II-II of FIG. 6C.

FIG. 10B is a cross-section view of the torsion axle of FIG. 6C in a second configuration, taken along line II-II of FIG. 6C.

FIG. 11A depicts a bar of parallel linkage with a mounting region that is configured for engagement with a coupling assembly of a planter assembly.

FIG. 11B depicts a front view of a locator assembly that is configured for engagement with the bar of FIG. 11A.

FIG. 11C depicts a side view of the locator assembly of FIG. 11B.

FIG. 12 depicts a side view of an example assembly, including the bar of FIG. 11A and the locator assembly of FIG. 11B.

FIG. 13 depicts a top view of the assembly of FIG. 12.

The use of cross-hatching or shading in the accompanying figures is generally provided to clarify the boundaries between adjacent elements, e.g., when shown in cross section, and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Change Flow Chart Fig and Description

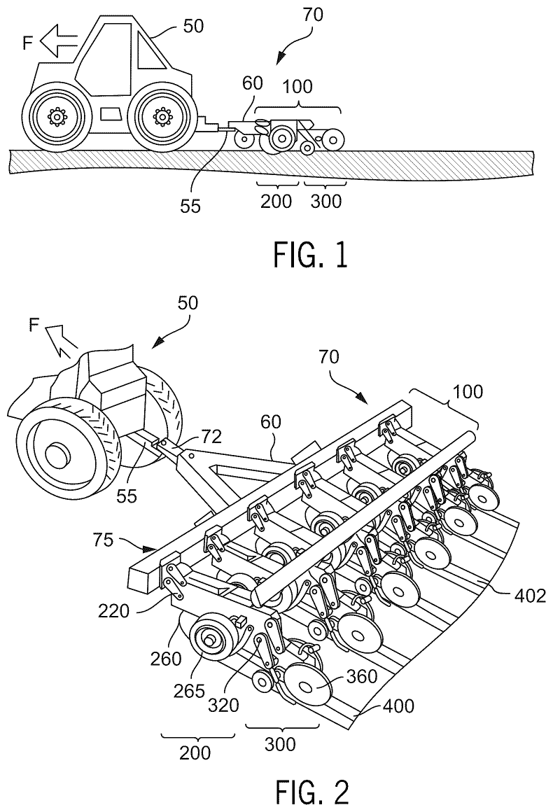

An exemplary embodiment of an agriculture planter 70 having one or more trailing arm assemblies 100 attached to an agricultural tractor 50 is shown in FIGS. 1 and 2. The agricultural tractor 50 may have a hitch receiver 55 extending rearward therefrom. As illustrated in FIG. 2, the planter 70 may include a planter frame 75 from which a planter frame 60 with a tongue or hitch 72 extends in a forward direction. The hitch 72 connects with the hitch receiver 55 to couple the planter 70 to the tractor 50. Various planter components are supported on the planter frame 75 and extend therefrom in a rearward direction. The tractor 50 tows the planter 70 in the direction of arrow F and provides power to the planter 70 (e.g., via a power take off (“PTO”), not shown) for powering the operations of the planter 70. Additional operations of the planter 70 may be powered by hydraulics or electrical motors (not shown) powered by the tractor 50.

Components of the planter 70 may include a plurality of trailing arm assemblies 100. The trailing arm assemblies 100 may function as row units for planting seeds and distributing liquid fertilizer. Each trailing arm assembly 100 may have a planter frame 60 or yoke that extends from the front of the trailing arm assembly 100. Each trailing arm assembly 100 may be equipped with a furrow opener assembly 200. Each trailing arm assembly 100 may also be equipped with a trailing furrow closer assembly 300.

In the exemplary embodiment shown, the furrow opener assembly 200 may be connected to the planter frame 60 via a parallel linkage 220, such as a four bar parallel linkage. The parallel linkage 220 allow the furrow opener assembly 200 and the furrow closer assembly 300 to move vertically to follow the terrain (e.g., contours of the field), overcome obstacles (e.g., debris or the like), or otherwise negotiate similar changes in a surface of a field 400. The furrow opener assembly 200 may include a guide wheel 265 and an opener disc 260. The furrow closer assembly 300 may include one or more closer wheels 360. In some embodiments, the furrow closer assembly 300 may further include a separate fertilizer opener wheel and a fertilizer dispenser (not shown). The vertical movement provided by the four bar linkage allows the trailing arm assemblies 100 to follow or translate up and down as the opener discs 260 and closer wheels 360 negotiate over or through an obstruction on a surface of a field 400 without adversely impacting seed deposit depth or resulting in damage to the components of the agricultural planter 70.

Because the trailing arm assemblies 100 are able to adjust to the contours of and variances in the surface of the field 400 through vertical translation via the parallel linkage 220, the opener discs 260 may be in consistent contact with the surface of the field 400, which may improve opening of furrows 402. Similarly, the trailing furrow closer wheels 360 may be in consistent contact with the surface of the field 400, which improves closing of the seed and fertilizer furrows 402.

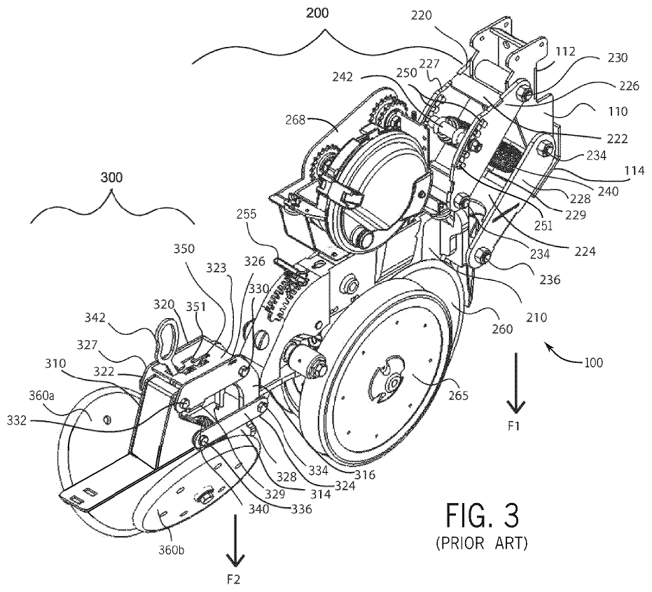

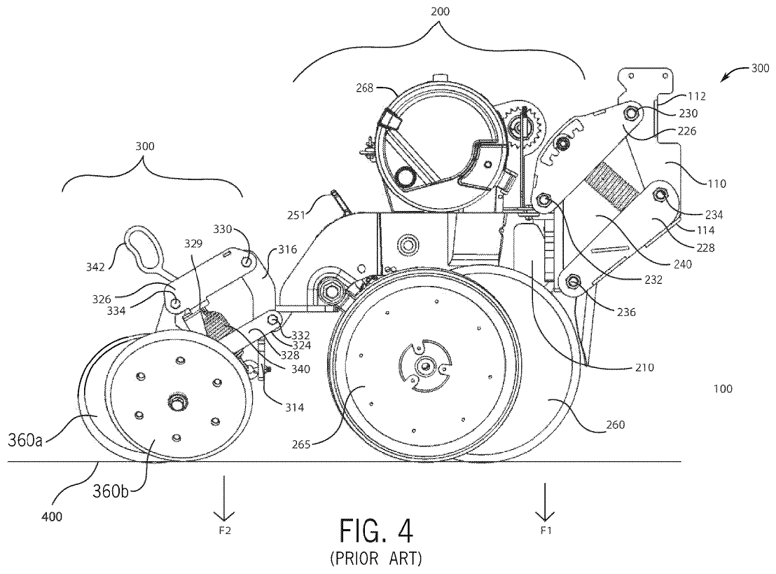

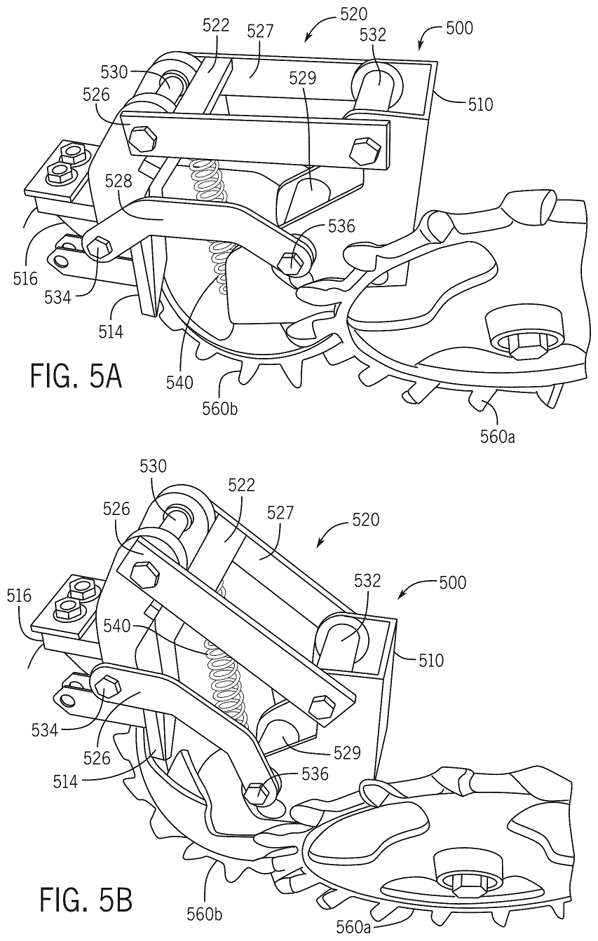

Exemplary embodiments of a typical trailing arm assembly 100 are depicted in FIGS. 3 and 4. FIGS. 3 and 4 are prior art depictions of the trailing arm assembly 100 with a furrow opener assembly 200 and a furrow closer assembly 300. This embodiment is shown and described for reference purposes for comparison to and orientation of the new parallel linkage system of the furrow closer assembly disclosed herein below and shown in accompanying FIGS. 5-10B. The furrow opener assembly 200 in the trailing arm assembly 100 may include an opener frame 210. One or more furrow opener discs 260, a gauge wheel 265, a seed hopper 268, and a fertilizer reservoir (not shown) may be attached to the opener frame 210. Each seed furrow opener disc 260 creates a furrow in which the planter 70 deposits seed in a manner well known in the art. The gauge wheel 265 assists in determining the depth at which the planter opener assembly 200 deposits the seed. The gauge wheel 265 is mounted to the frame 210 via a gauge wheel lever arm, which is pivotally coupled to the frame 210.

The furrow opener assembly 200 may be coupled to the planter frame 75 via a connection that allows the trailing arm assembly 100 to move relative to the frame 75. In any of the embodiments contemplated herein, the connection may be configured to maintain an approximately constant relative orientation between the furrow opener assembly 200 and the frame 75 through the range of motion of the trailing arm assembly 100. Any mechanical connection operable to maintain this relationship may be used. For example, the furrow opener assembly 200 may connect to the frame 75 via a parallel linkage 220. In any of the embodiments disclosed herein, the parallel linkage 220 may be a four bar parallel linkage. While a four bar parallel linkage 220 is shown in the figures, other connection mechanisms may be used as well. In other implementations, which may be used in any embodiment, a slide mechanism or a rail mechanism may connect the furrow opener assembly 200 of the trailing arm assembly 100 to the frame 75.

In any of the embodiments disclosed herein, the furrow closer assembly 300 may include a closer frame 310. The closer frame 310 may be connected to one or more furrow closer discs or wheels 360, fertilizer opener discs, fertilizer injectors, or similar planter implements. Each furrow closer disc or wheel 360 closes a furrow over a deposited seed in a manner well known in the art. Any type of closer disc or wheel 360 may be used including flat discs, discs with tamping appendages, tires, and “Mohawk”-style discs, as well as others.

The furrow closer assembly 300 may be coupled to the opener frame 210 via a connection that allows the furrow closer assembly 300 to move relative to the opener frame 210. In any of the embodiments described herein, the connection may be configured the connection may be configured to maintain an approximately constant relative orientation between the furrow closer assembly 300 and the opener frame 210 through the range of motion of the furrow closer assembly 300. Any mechanical connection operable to maintain this relationship may be used. For example, the furrow closer assembly 300 may connect to the opener frame 210 via a parallel linkage 320. In any of the embodiments contemplated herein, the parallel linkage 320 may be a four bar parallel linkage. While a four bar parallel linkage is shown in the figures connecting the furrow closer assembly 300 to the opener frame 210, other connection mechanisms may be used as well. For example, a slide mechanism or a rail mechanism may be used in alternate embodiments.

The parallel linkages 220 coupled between each furrow opener assembly 200 and the planter frame 75 may have a first opener linking bar 226 and a second opener linking bar 228 arranged parallel to the first opener linking bar 226. The first opener linking bar 226 may be pivotably connected at a first end on a first opener pivot bearing 230 to a frame bracket 110 that is rigidly fixed (either permanently or removably) to the planter frame 75. The first opener linking bar 226 may be pivotably connected at a second end on a second opener pivot bearing 232 to the opener frame 210 of the furrow opener assembly 200. In this arrangement, the first opener linking bar 226 allows movement between the first frame 210 and the frame bracket 110. The second opener linking bar 228 may be pivotably connected at a first end on a third opener pivot bearing 234 to the frame bracket 110 that is rigidly fixed to the planter frame 75. The second opener linking bar 226 may be pivotably connected at a second end on a fourth opener pivot bearing 236 to the opener frame 210 of the furrow opener assembly 200.

The first opener linking bar 226 and the second opener linking bar 228 may be positioned in parallel relative to one another such that planes passing through the first and second opener pivot bearings 230, 232 and the third and fourth opener pivot bearings 234, 236, respectively, are parallel to one another. In this relationship, as the first opener linking bar 226 and the second opener linking bar 228 articulate through their range of motion, they remain parallel to one another.

In any embodiment, for example, as shown in FIG. 3, the parallel linkage 220 may also include a third opener linking bar 227 and a fourth opener linking bar 229 that are spaced apart from the first opener linking bar 226 and the second opener linking bar 228, respectively, and are positioned as mirror opposites thereof. The third opener linking bar 227 and the fourth opener linking bar 229 may be attached to the frame bracket 110 at first ends and to the opener frame 210 at second ends on pivot bearings located on the same axes as the pivot axes of the first, second, third, and fourth opener pivot bearings 230, 232, 234, 236, respectively. In any embodiment, the first and second opener pivot bearings 230, 232 may be shafts supported by the frame bracket 110 or the opener frame 210 to extend between and support both the first opener linking bar 226 and the third opener linking bar 227. Similarly, in any embodiment, the third and fourth opener pivot bearings 234, 236 may be shafts supported by the frame bracket 110 or the opener frame 210 to extend between and support both the second opener linking bar 228 and the fourth opener linking bar 229.

In any contemplated implementation, the first opener linking bar 226 and the third opener linking bar 227 of the parallel linkage 220 may be rigidly connected, for example, welded together with a cross-brace 222 to form a unitary structure. Similarly, the second opener linking bar 228 and the fourth opener linking bar 229 may be rigidly connected, for example, welded together with a cross-brace 224 to form a unitary structure. Such unitary formation may increase the lateral rigidity of the parallel linkage 220. The unitary formation of either or both the upper and lower opener linking bars 226, 227, 228, 229 may be accomplished by means other than cross bracing. For example, each pair of linking bars may be cast, molded, machined, stamped, welded, or formed together by any other method as a single piece. In any embodiment, the frame bracket 110 may have an engagement portion 112 that is fixedly attachable or removably attachable to a planter towing frame 75. The engagement portion 112 may provide stability proximal to the sides of the linkage 220 such that twisting of the trailing arm assembly 100 is minimized.

In the embodiment of FIGS. 3 and 4, the frame bracket 110 of the furrow opener assembly 200 may also include a mounting plate 114 positioned adjacent to or below the third opener pivot bearing 234 and adjacent to or between the second opener linking bar 228 and the fourth opener linking bar 229. As shown in FIGS. 3 and 4, the mounting plate 114 may be below the third opener pivot bearing 234 and also extend or bend under the second opener linking bar 228 and the fourth opener linking bar 229. By extending outward and under the second opener linking bar 228 and the fourth opener linking bar 229, the mounting plate 114 may be positioned to stop the parallel linkage 220 from allowing rotation beyond a certain point. For example, the mounting plate 114 may limit the second opener linking bar 228 and the fourth opener linking bar 229 from extending beyond 10-80 degrees off of the horizontal plane by being positioned to contact the second opener linking bar 228 and the fourth opener linking bar 229 at an angular orientation between 20-70 degrees off horizontal. In other examples, the angle of the mounting plate 114 may be between 20-70 degrees or more particularly between 30-60 degrees. In one example, the angle of the mounting plate 114 may be approximately 35 degrees with respect to the horizontal.

It is desirable that the trailing arms 100 provide a relatively constant downward pressure. Such a constant and consistent downward pressure allows for continuous opening and closing of furrows 402 and provides a consistent seed depth, preventing seed deposition from being too shallow or too deep, each of which negatively impacts germination. In the embodiment of FIGS. 3 and 4, a biasing device 240 is mounted between the parallel linkage 220 and the planter frame 75. In various known embodiments, the biasing device can be a tension spring, a torsion spring positioned around the third opener pivot bearing 234, or a hydraulic or pneumatic cylinder operable to extend or contract. In the embodiment shown, the biasing device 240 is a heavy gauge tension spring that is connected at a first end to the first opener linking bar 226 and the third opener linking bar 227 of the parallel linkage 220 and at a second end to the mounting plate 114. In this manner, the second end of the biasing device 240 has little or no movement relative to the planter frame 75. In some embodiments, the first end of the biasing device 240 may be connected to the cross brace 222 extending between the first opener linking bar 226 and the third opener linking bar 227 forming a unitary upper bar of the parallel linkage 220. In other embodiments, as shown in FIGS. 3 and 4, the first end of the biasing device 240 may be connected to a separate anchor bar 242 that extends between the first opener linking bar 226 and the third opener linking bar 227. The position of the anchor bar 242 may be adjustable as further described below.

The biasing device 240 may exert a force directly between the parallel linkage 220 and the mounting plate 114, with a resultant force on the opener frame 210 of the furrow opener assembly 200 represented as F1, i.e., downward and effectively normal to the surface of the field 400, regardless of the pitch of slope of the field at any particular location. The parallel linkage 220 is connected between the opener frame 210 and the frame bracket 110 such that the parallel linkage 220 maintains an angular orientation of the opener frame 210 with respect to the planter frame 75. This angular orientation may be generally or substantially orthogonal to the effective downward force F1 of the adjustable biasing device 240. While the actual force exerted by the biasing device 240 may not be entirely downward or normal to the field 400 as indicated in FIGS. 3 and 4, the interaction between the biasing device 240 and the parallel linkage 220 may result in a primarily downward force on the opener frame 210. This downward force may counteract upward forces on the furrow opener assembly (e.g., rocks, hard pack soil, ridges, or humps in the field 400). The biasing device 240 thereby helps maintain a downward force (in addition to the weight of the furrow opener assembly 200) on the opener frame 210 and all implements attached thereto (e.g., the opener disc 260 and the gauge wheel 265) against the field 400.

As noted, in any of the embodiments, the position of the first end of the biasing device 240 may be adjustable along a length of the upper portion of the parallel linkage 220. The adjustment in position of the first end of the biasing device 240 (e.g., when a tension spring) allows for the resting tension on the parallel linkage 220 to be increased or decreased. For example, as shown in FIGS. 3 and 4, the anchor bar 242 may connect to the parallel linkage 220 at any of a variety of positions along about 50% of the lengths of the first linking bar 226 and the third linking bar 227. As shown, elongate slots 250 may be formed in the walls of the first linking bar 226 and the third linking bar 227 into which lateral ends of the anchor bar 242 are positioned. A bottom surface of the elongate slots 250 may be formed as a plurality of detents 251. The lateral ends of the anchor bar 242 may engage the elongate slots 250 and seat within any opposing pair of detents 251. The anchor bar 242 may be sized to slide within and along the elongated slot between the detents 251. The biasing device 240 pulls on the anchor bar 242 and holds it in place in a selected pair of detents 251 in the slots 250. The anchor bar 242 may be a shaft or rod or pin that extends between the first linking bar 226 and the third linking bar 227.

In any embodiment contemplated herein, the opener frame 210 may include an adjustment mechanism 255 operable to change the position of the gauge wheel 265 relative to the opener frame 210. The adjustment mechanism 255 may be operated by an adjustment lever, which raises or lowers the gauge wheel 265. A linkage may extend between a bottom end of the lever and the opener frame 210. The position of the adjustment mechanism 255 may be configured to set the gauge wheel 265 at a desired position relative to the opener frame 210. The adjustment mechanism 255 thus sets the depth of furrows 402 created by the opener disc 260 by adjusting the vertical position of the gauge wheel 265 relative to the opener frame 210 and the opener disc 260. The position of the gauge wheel 265 also affects the static position of the opener frame 210 with respect to the planter frame 75 and thus can affect the tension exerted by the biasing device 240.

The trailing arm assembly 100 may also include a furrow closer assembly 300 that supports implements operable to close and/or fertilize a furrow 402. As shown in FIGS. 3 and 4, the furrow closer assembly 300 may include a closer frame 310. The opener frame 210 and the closer frame 310 may be connected to one another such that the closer frame 310 may operatively move independently with respect to the opener frame 210 such that the furrow closer assembly 300 may articulate vertically relative to the opener trailing arm assembly 200. One or more closing wheels 360 may be rotationally mounted to the closer frame 310. The closing wheels 360 may generally operate at a similar level as the gauge wheels 265 to close the furrows 402 rather than at the lower depth of the opener disc 260 that cuts the furrows 402. In some embodiments (not shown herein), the closer frame 310 may also support a fertilizer disc and/or a fertilizer distribution system.

In any of the embodiments disclosed herein, the closer frame 310 may be connected to the opener frame 210 via a second parallel linkage 320. The second parallel linkage 320 may have a first closer linking bar 326 and a second closer linking bar 328. The first closer linking bar 326 may be pivotably connected at a first end on a first closer pivot bearing 330 to the opener frame 210. The first closer linking bar 326 may be pivotably connected at a second end on a second closer pivot bearing 332 to the closer frame 310. In this arrangement, the first closer linking bar 326 allows movement between the opener frame 210 and the closer frame 310. The second closer linking bar 328 may be pivotably connected at a first end on a third closer pivot bearing 334 to the opener frame 210. The second closer linking bar 326 may be pivotably connected at a second end on a fourth closer pivot bearing 336 to the closer frame 310.

The first closer linking bar 326 and the second closer linking bar 328 may be positioned in parallel relative to one another such that planes passing through the first and second closer pivot bearings 330, 332 and the third and fourth closer pivot bearings 334, 336, respectively, are parallel to one another. In this relationship, as the first closer linking bar 326 and the second closer linking bar 328 articulate through their range of motion, they remain parallel to one another. The parallel linkage 220 of the furrow opener assembly 200 provides a first degree of articulation for movement of the components positioned rearward of furrow opener assembly 200, e.g. the closing assembly 300. The second parallel linkage 320 of the closing assembly 300 provides a second degree of articulation that is independent of the opener assembly 200 and provides additional vertical range of movement for the closing wheels 360a, 360b.

In any embodiment, for example, as shown in FIG. 3, the second parallel linkage 320 may also include a third closer linking bar 327 and a fourth closer linking bar 329 that are spaced apart from the first closer linking bar 326 and the second closer linking bar 328, respectively, and are positioned as mirror opposites thereof. The third closer linking bar 327 and the fourth closer linking bar 329 may be attached to the opener frame 210 at first ends and to the closer frame 310 at second ends on pivot bearings located on the same axes as the pivot axes of the first, second, third, and fourth closer pivot bearings 330, 332, 334, 336, respectively. In any embodiment, the first and second closer pivot bearings 330, 332 may be shafts supported by the opener frame 210 to extend between and support both the first closer linking bar 326 and the third closer linking bar 327. Similarly, in any embodiment, the third and fourth closer pivot bearings 334, 336 may be shafts supported by the closer frame 310 to extend between and support both the second closer linking bar 328 and the fourth closer linking bar 329.

In the prior art embodiment shown in FIGS. 3 and 4, the closer frame 310 may include a closer mounting bracket 316 fixedly attached or removably attachable to the opener frame 210. The closer frame 310 may be movably attached to the closer mounting bracket 316 via the second parallel linkage 320, preferably in a manner that provides stability to the sides of the second parallel linkage 320 to minimize twisting of the furrow closer assembly 300. The closer mounting bracket 316 may also include a closer mounting plate 314 that connects to a biasing device 340. The closer mounting plate 314 may be located above, below, or in between pivots 330 and 332. As shown in FIGS. 3 and 4, the closer mounting plate 314 may be below the third closer pivot bearing 334 and also extend downward beyond or bend under the second closer linking bar 328 and the fourth closer linking bar 329. By extending outward and under the second linking bar 328 and the fourth linking bar 329, the closer mounting plate 314 may be positioned to stop the parallel linkage 320 from allowing rotation beyond a certain point. For example, the closer mounting plate 314 may limit the travel of the second closer linking bar 328 and the fourth closer linking bar 329 by being positioned to contact the second closer linking bar 328 and the fourth closer linking bar 329 at a chosen angular orientation.

In any contemplated implementation, the first closer linking bar 326 and the third closer linking bar 327 of the second parallel linkage 320 may be rigidly connected, for example, welded together with a cross-brace plate 322 to form a unitary structure. Similarly (although not presented in the figures), the second closer linking bar 328 and the fourth closer linking bar 329 may be rigidly connected, for example, welded together with a cross-brace to form a unitary structure. Such unitary formation may increase the lateral rigidity of the second parallel linkage 320. The unitary formation of either or both the upper and lower closer linking bars 326, 327, 328, 329 may be accomplished by means other than cross bracing. For example, each pair of linking bars may be cast, molded, machined, stamped, welded, or formed together by any other method as a single piece. In any embodiment, the closer mounting bracket 316 may be fixedly attached to (but generally removable from) the opener frame 210. The closer mounting bracket 316 may provide stability proximal to the sides of the second parallel linkage 320 such that twisting of the furrow closer assembly 300 is minimized. Further, the closer frame 310 may be formed as a rigid box structure that also provides external stability to the second parallel linkage 320 as the third and fourth closer pivot bearings 334, 336 are attached thereto.

In the prior art embodiment of FIGS. 3 and 4, a biasing device 340 is mounted between the parallel linkage 320 and the closer mounting plate 314 and, thus, with respect to the opener frame 210. In various known embodiments, the biasing device 340 can be a tension spring, a torsion spring positioned around the third closer pivot bearing 334, or a hydraulic or pneumatic cylinder operable to extend or contract. In the embodiment shown, the biasing device 340 is a heavy gauge tension spring that is connected at a first end to the first closer linking bar 326 and the third closer linking bar 327 of the second parallel linkage 320 and at a second end to the closer mounting plate 314. In this manner, the second end of the biasing device 340 has little or no movement relative to the opener frame 210. In some embodiments, the first end of the biasing device 340 may be connected to the cross brace plate 322 extending between the first closer linking bar 326 and the third closer linking bar 327 forming a unitary upper bar of the parallel linkage 320. In other embodiments, as shown in FIGS. 3 and 4, the first end of the biasing device 340 may be connected to a separate anchor lever 342 positioned between the first closer linking bar 226 and the third closer linking bar 227. The position of the anchor lever 342 may be adjustable as further described below.

The biasing device 340 may exert a force directly between the second parallel linkage 320 and the closer mounting plate 314, with a resultant force on the closer frame 210 of the furrow closer assembly 300 represented as F2, i.e., downward and effectively normal to the surface of the field 400, regardless of the pitch of slope of the field 400 at any particular location. The second parallel linkage 320 is connected between the closer frame 310 and the closer mounting bracket or plate 314 such that the second parallel linkage 320 maintains an angular orientation of the furrow closer assembly 300 with respect to the opener frame 210. This angular orientation may be generally or substantially orthogonal to the effective downward force F2 of the biasing device 340. While the actual force exerted by the biasing device 340 may not be entirely downward or normal to the field 400 as indicated in FIGS. 3 and 4, the interaction between the biasing device 340 and the second parallel linkage 320 may result in a primarily downward force on the closer frame 310. This downward force may counteract upward forces on the furrow closer assembly 300 (e.g., rocks, hard pack soil, ridges, or humps in the field 400). The biasing device 340 thereby helps maintain a downward force (in addition to the weight of the furrow closer assembly 300) on the closer frame 310 and all implements attached thereto (e.g., the closer wheels 360) against the field 400.

As noted, in any of the embodiments, the position of the first end of the second biasing device 340 may be adjustable along a length of the upper portion of the second parallel linkage 320. The adjustment in position of the first end of the second biasing device 340 (e.g., when a tension spring) allows for the tension on the second parallel linkage 320 to be increased or decreased. For example, as shown in FIGS. 3 and 4, the anchor lever 342 may have an upper end with a handle and a lower end that connects with the first end of the second biasing device 340. A mid-portion of the anchor lever 342 may be pivotably mounted with respect to the second parallel linkage 320, e.g., mounted to rotate about the second closer pivot bearing 332 (not visible). The second closer pivot bearing thus acts as a fulcrum for the anchor lever 342 to increase or reduce the static tension on the second biasing device 340. The upper end of the anchor lever 342 may interface with the cross brace plate 322 on the second parallel linkage 320 at any of a variety of positions along about 50%-80% of the lengths of the first closer linking bar 326 and the third closer linking bar 327. As shown, an elongate slot 350 may be formed in the wall of the cross brace plate 322 within which the anchor lever 342 is positioned. The sides of the elongate slot 350 may be formed with a plurality of detents 351. The anchor lever 342 may engage the elongate slot 350 and seat within any detent 351 along the length of the elongate slot 350, pivoting about the second closer pivot bearing 332 and thus moving the lower end of the anchor lever 342 farther from or nearer to the closer mounting plate 314, thereby increasing or decreasing tension in the second biasing device 340. The second biasing device 340 pulls on the anchor lever 342 and holds it in place in a selected detent 351 in the slot 350.

New implementations of a second parallel linkage 520 and components thereof for use with a furrow closing assembly 500 are depicted in FIGS. 5A-10. In these implementations, the downward force of the may be a pneumatic cylinder device, hydraulic cylinder device, screw-drive linear actuator, or a spring such as a coil spring. In one example, the biasing device may include a configuration in which a threaded lead screw is engaged with a nut having corresponding threads. The lead screw may be rotated axially by operation of an associated electric motor. The rotation of the lead screw may drive the nut along the axial length of the lead screw. The nut may be fixedly engaged with an external shaft, thrust tube, casing or other component that may be driven axially, reciprocally based on the advancement of the nut along the lead screw. It will be appreciated that the substantially any other arrangement of mechanical mechanisms may be used to facilitate the conversion of rotary motion from the electric motor to linear motion of a shaft or tube, including other screw-type mechanisms, such as ball screws, roller screws and so on. Wheel and axle type combination may be used in other examples in which a wheel component rotate in order to produce linear motion from a belt or chain. Additionally or alternatively, cam-based linear actuator may be used, particular for low-travel applications.

FIGS. 5A and 5B depict a basic embodiment of a furrow closing assembly 500 incorporating the biasing device 540. As in the prior art embodiments, the furrow closing assembly 500 may be built around a closer frame 510. The closer frame 510 may be connected to the opener frame 210 such that the closer frame 510 may operatively move independently with respect to the opener frame 210 and allow the furrow closer assembly 500 to articulate vertically relative to the opener trailing arm assembly 200. One or more closing wheels 560a, 560b may be rotationally mounted to the closer frame 510. The closing wheels 560a, 560b may generally operate at a similar level as the gauge wheels 265 to close the furrows 402 rather than at the lower depth of the opener disc 260 that cuts the furrows 402. In some embodiments (not shown herein), the closer frame 510 may also support a fertilizer disc and/or a fertilizer distribution system.

In any of the embodiments disclosed herein, the closer frame 510 may be connected to the opener frame 210 via a second parallel linkage 520. The closer frame 510 may include a closer mounting bracket 516 fixedly attached (either permanently or removably) to the opener frame 210. The closer frame 510 may be movably attached to the closer mounting bracket 516 via the second parallel linkage 520, preferably in a manner that provides stability to the sides of the second parallel linkage 520 to minimize twisting of the furrow closer assembly 500. The second parallel linkage 520 may have a first closer linking bar 526 and a second closer linking bar 528. The first closer linking bar 526 may be pivotably connected at a first end on a first closer pivot bearing 530 to the closer mounting bracket 516. The first closer linking bar 526 may be pivotably connected at a second end on a second closer pivot bearing 532 to the closer frame 510. In this arrangement, the first closer linking bar 526 allows movement between the opener frame 210 and the closer frame 510. The second closer linking bar 528 may be pivotably connected at a first end on a third closer pivot bearing 534 to the closer mounting bracket 516. The second closer linking bar 528 may be pivotably connected at a second end on a fourth closer pivot bearing 536 to the closer frame 510.

The first closer linking bar 526 and the second closer linking bar 528 may be positioned in parallel relative to one another such that planes passing through the first and second closer pivot bearings 530, 532 and the third and fourth closer pivot bearings 534, 536, respectively, are parallel to one another. In this relationship, as the first closer linking bar 526 and the second closer linking bar 528 articulate through their range of motion, they remain parallel to one another. The parallel linkage 220 of the furrow opener assembly 200 provides a first degree of articulation for movement of the components positioned rearward of furrow opener assembly 200, e.g. the closing assembly 500. The second parallel linkage 520 of the closing assembly 500 provides a second degree of articulation that is independent of the opener assembly 200 and provides additional vertical range of movement for the closing wheels 560a, 560b.

In any embodiment, for example, as shown in FIGS. 5A and 5B, the second parallel linkage 520 may also include a third closer linking bar 527 and a fourth closer linking bar 529 that are spaced apart from the first closer linking bar 526 and the second closer linking bar 528, respectively, and are positioned as mirror opposites thereof. The third closer linking bar 527 and the fourth closer linking bar 529 may be attached to the closer mounting bracket 516 at first ends and to the closer frame 510 at second ends on pivot bearings located on the same axes as the pivot axes of the first, second, third, and fourth closer pivot bearings 530, 532, 534, 536, respectively. In any embodiment, the first and second closer pivot bearings 530, 532 may be shafts supported by the closer mounting bracket 516 to extend between and support both the first closer linking bar 526 and the third closer linking bar 527. Similarly, in any embodiment, the third and fourth closer pivot bearings 534, 536 may be shafts supported by the closer frame 510 to extend between and support both the second closer linking bar 528 and the fourth closer linking bar 529.

As shown in FIGS. 5A and 5B, the closer mounting bracket 516 may also include a closer mounting plate 514 that connects to the base of the biasing device 540. The closer mounting plate 514 may be located above, below, or in between pivots 530 and 532. As shown in FIGS. 5 and 4, the closer mounting plate 514 may be below the third closer pivot bearing 534 and also extend downward beyond or bend under the second closer linking bar 528 and the fourth closer linking bar 529. By extending outward and under the second linking bar 528 and the fourth linking bar 529, the closer mounting plate 514 may provide a platform for mounting the base of the biasing device 540 thereon.

In any contemplated implementation, the first closer linking bar 526 and the third closer linking bar 527 of the second parallel linkage 520 may be rigidly connected, for example, welded together with a cross-brace plate 522 to form a unitary structure. Similarly (although not presented in the figures), the second closer linking bar 528 and the fourth closer linking bar 529 may be rigidly connected, for example, welded together with a cross-brace to form a unitary structure. Such unitary formation may increase the lateral rigidity of the second parallel linkage 520. The unitary formation of either or both the upper and lower closer linking bars 526, 527, 528, 529 may be accomplished by means other than cross bracing. For example, each pair of linking bars may be cast, molded, machined, stamped, welded, or formed together by any other method as a single piece. In any embodiment, the closer mounting bracket 516 may be fixedly attached to (but generally removable from) the opener frame 210. The closer mounting bracket 516 may provide stability proximal to the sides of the second parallel linkage 520 such that twisting of the furrow closer assembly 500 is minimized. Further, the closer frame 510 may be formed as a rigid box structure that also provides external stability to the second parallel linkage 520 as the third and fourth closer pivot bearings 534, 536 are attached thereto.

As noted, the base of the biasing device 540 may be mounted on the closer mounting plate 514, which is a stable surface with respect to the furrow opener assembly 200, as the closer mounting plate 514 is rigidly attached to the closer mounting bracket 516, which in turn is rigidly mounted to the opener frame 210 of the furrow opener assembly 200.

Many, and possibly all, of the features, components, and/or parts, including the arrangements and configurations thereof shown in FIGS. 5A and 5B may be included, either alone or in any combination, in any of the other examples of devices, features, components, and parts shown in the other figures described herein. Likewise, any of the features, components, and/or parts, including the arrangements and configurations thereof shown and described with reference to the other figures may be included, either alone or in any combination, in the example of the devices, features, components, and parts shown in FIGS. 5A and 5B.

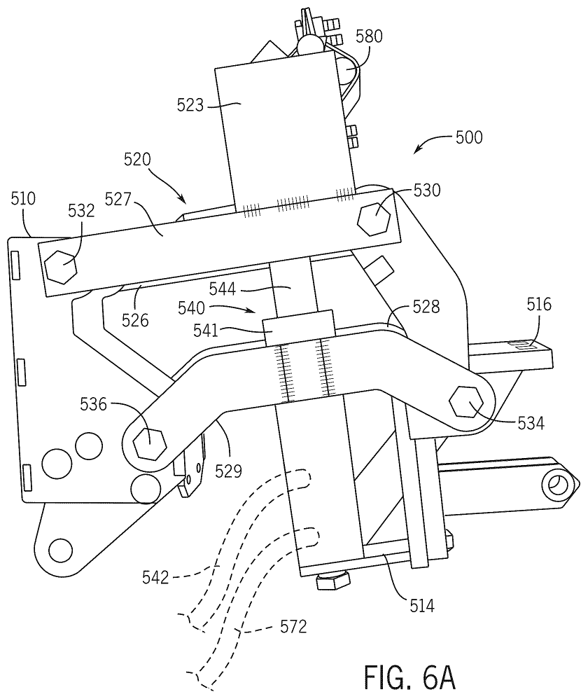

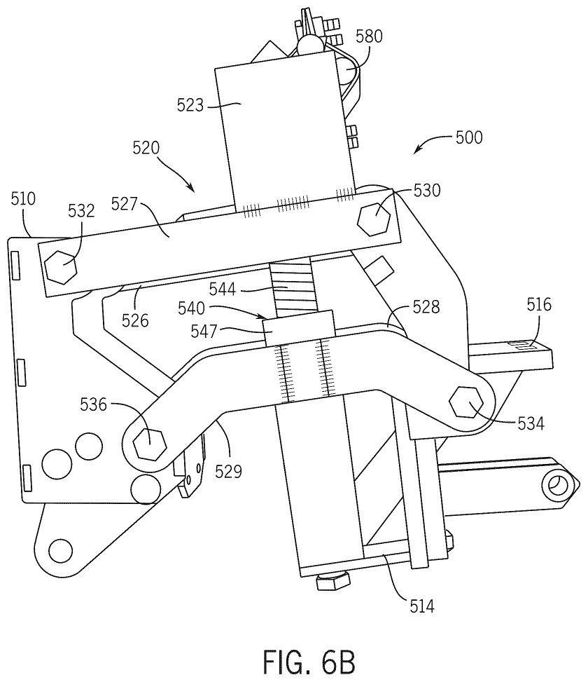

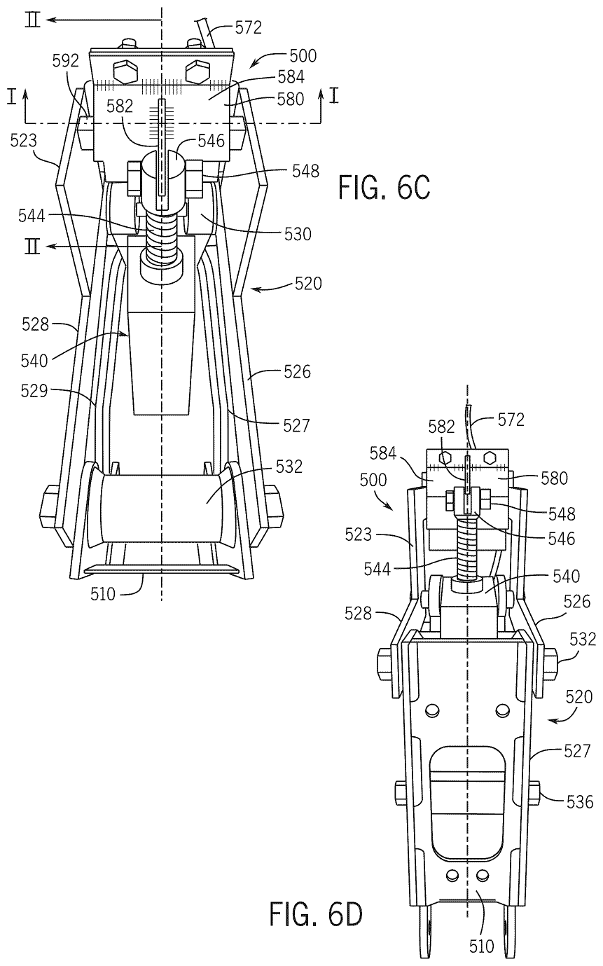

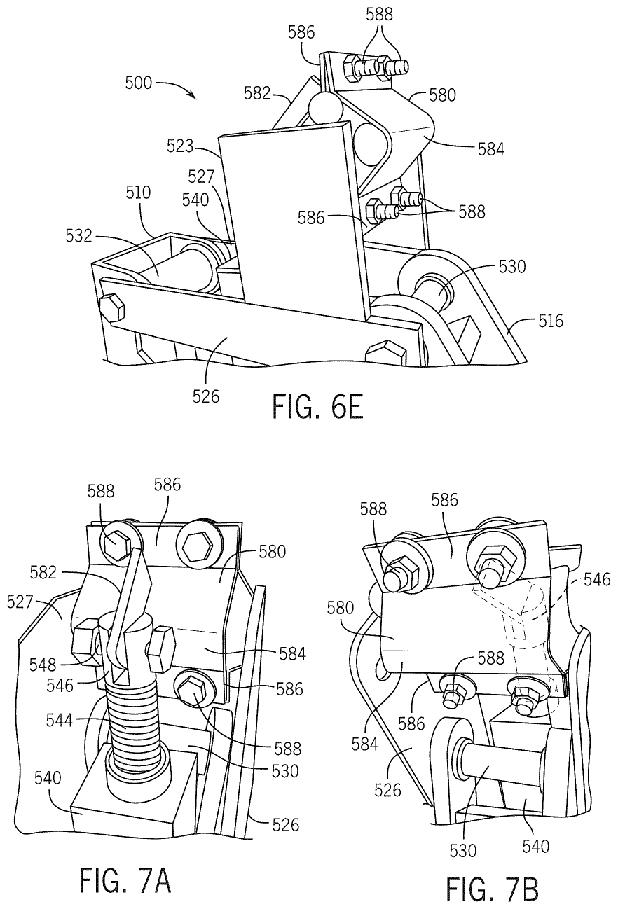

FIG. 6A illustrates an embodiment with the biasing device 540 including a biasing cylinder assembly 541 having a first cylinder 543 and a second cylinder or shaft 544 coupled to the first cylinder 543 such that the second cylinder 544 can translate longitudinally relative to the first cylinder 543. In this way, the overall length of the biasing cylinder assembly 541 can be altered. In one example, the biasing cylinder assembly 541 may be a pneumatic cylinder assembly including inlet and outlet tubes 542, 572, respectively, to control the amount of air in the first cylinder 543, which determines or controls the extent to which the second cylinder 544 extends from the first cylinder 543. In one example, the biasing cylinder assembly 541 may be a hydraulic cylinder assembly including inlet and outlet tubes 542, 572, respectively, to control the amount of fluid in the first cylinder 543, which determines or controls the extent to which the second cylinder 544 extends from the first cylinder 543. In at least one example, the linear actuator 540 can be a pneumatic device such as a pneumatic cylinder or an airbag device.

When the second cylinder 544 is extended, it presses against the cross-brace plate 522 and thus drives the closer frame 510 downward due to the pivot motion provided by the second parallel linkage 520. While the second cylinder 544 may only extend a few inches, the four bar configuration of the second parallel linkage 520 and the much longer lengths of the closer linking bars 526, 527, 528, 529 translates the short extension of the second cylinder 544 into a much longer range of travel. For example, 2 inches of extension of the second cylinder 544 can translate into 6-8 inches or more of vertical travel for the closer frame 510 (and thereby the attached closer wheels 560a, 560b) depending upon the lengths of the closer linking bars 526, 527, 528, 529 in the second parallel linkage 520. Further, if a closer wheel 560a, 560b or press wheel is further attached to a walking arm beam (e.g., as described in U.S. Patent Application Publication No. 2017/0208736), an additional 2 inches of vertical travel is achievable for a total of about 9 inches of vertical movement of implements attached to the furrow closer assembly 500.

When the second cylinder 544 is retracted, it may pull the closer frame 510 upward, thereby lifting the closer wheels 560a, 560b above the surface of the field 400. When the biasing device 540 is in the retracted position, the furrow closer assembly 500 is raised above the field 400 and the tractor 50 can be driven at a faster speed for moving between fields or can avoid impacts to the furrow closer assembly when traveling over irrigation troughs, through drainages, swales, or culverts, or over terraces.

Many, and possibly all, of the features, components, and/or parts, including the arrangements and configurations thereof shown in FIG. 6A may be included, either alone or in any combination, in any of the other examples of devices, features, components, and parts shown in the other figures described herein. Likewise, any of the features, components, and/or parts, including the arrangements and configurations thereof shown and described with reference to the other figures may be included, either alone or in any combination, in the example of the devices, features, components, and parts shown in FIG. 6A.

FIG. 6B shows another embodiment with the biasing device 540 including a linear screw actuator 547 including a housing 553 and a shaft 544 in the form of a lead screw 544 coupled with the torsion axle 580. When the lead screw 544 is extended, it presses against the cross-brace plate 522 and thus drives the closer frame 510 downward due to the pivot motion provided by the second parallel linkage 520. While the lead screw 544 may only extend a few inches, the four bar configuration of the second parallel linkage 520 and the much longer lengths of the closer linking bars 526, 527, 528, 529 translates the short extension of the lead screw 544 into a much longer range of travel. For example, 2 inches of extension of the lead screw 544 can translate into 6-8 inches or more of vertical travel for the closer frame 510 (and thereby the attached closer wheels 560a, 560b) depending upon the lengths of the closer linking bars 526, 527, 528, 529 in the second parallel linkage 520. Further, if a closer wheel 560a, 560b or press wheel is further attached to a walking arm beam (e.g., as described in U.S. Patent Application Publication No. 2017/0208736), an additional 2 inches of vertical travel is achievable for a total of about 9 inches of vertical movement of implements attached to the furrow closer assembly 500.

When the shaft or lead screw 544 is retracted, it may pull the closer frame 510 upward, thereby lifting the closer wheels 560a, 560b above the surface of the field 400. When the biasing device 540 is in the retracted position, the furrow closer assembly 500 is raised above the field 400 and the tractor 50 can be driven at a faster speed for moving between fields or can avoid impacts to the furrow closer assembly when traveling over irrigation troughs, through drainages, swales, or culverts, or over terraces.

Many, and possibly all, of the features, components, and/or parts, including the arrangements and configurations thereof shown in FIG. 6B may be included, either alone or in any combination, in any of the other examples of devices, features, components, and parts shown in the other figures described herein. Likewise, any of the features, components, and/or parts, including the arrangements and configurations thereof shown and described with reference to the other figures may be included, either alone or in any combination, in the example of the devices, features, components, and parts shown in FIG. 6B.

The biasing device 540 may provide between 50 and 150 pounds or more of downward force or lift force on the furrow closing assembly 500 in a very short, reactive period of time. It may be preferable that the biasing device be a linear screw drive, a coil springs, or a pneumatic or hydraulic cylinder assembly in order to provide adequate force and static resistance to external forces. For example, in one embodiment, the biasing device 540 can exert or pull 125 pounds of force on the closer frame 510 and the shaft can travel 1.78 inches in one second, with a full extension stroke of 2 inches.

An alternative embodiment of the second parallel linkage 520 including a linear actuator 540 for use with a furrow closer assembly 500 is depicted in FIGS. 6B-6E. The parallel linkage 520 in this embodiment is substantially the same as shown in FIGS. 5A and 5B. However, two additional components have been added to the parallel linkage 520 to operate in conjunction with the linear screw actuator 547 of the biasing device 540 and provide additional functionality to the control of the closer furrow assembly 500. The first additional component may be a torsion axle 580 mounted to a torsion frame 523 fixed to and extending upward from the first closer linking bar 526 and the third closer linking bar 527. An alternative embodiment of the second parallel linkage 520 is depicted in FIGS. 7A-7C. In this embodiment, the first and third closer linking bars 526, 527 are formed as extended plates with sufficient surface area for the torsion axle 580 to mount therebetween. The torsion axle 580 is further pivotably connected to the shaft 544 of the linear actuator 540.

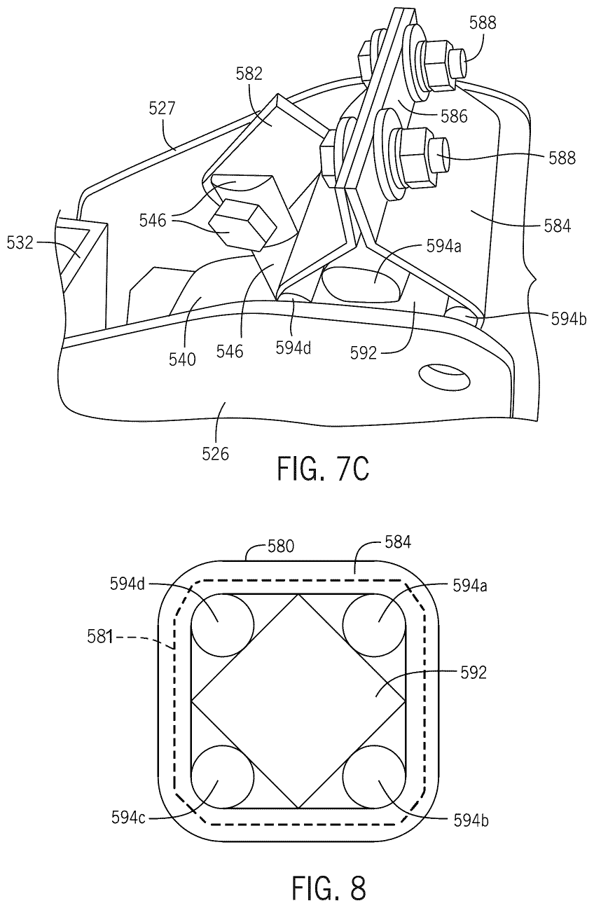

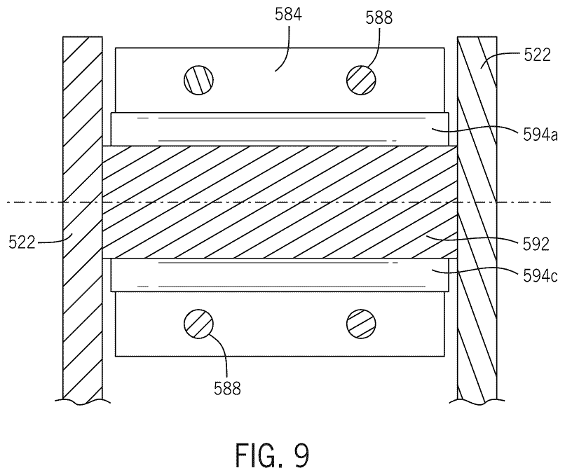

The torsion axle 580 is further shown schematically in cross section in FIG. 8. In any embodiment, the torsion axle 580 may be formed about a torsion block 592 fixedly attached between the torsion frame 523 extending above the first closer linking bar 526 and the third closer linking bar 527. For example, as shown in the cross-sectional view of FIG. 9, the torsion block 592 may be fixedly attached to the torsion frame 523. The torsion frame 523 is fixedly attached to the closer bars 526, 527 of the parallel linkage 520. In other cases, the torsion block 592 may be directly fixed to the first and third closer linking bars 526, 527 as shown in FIGS. 7A-7C. The torsion block 592 may be a piece of square steel block or square steel tube welded at each end to the torsion frame 523 or the first and third closer linking bars 526, 527. Torsion biasing members 594a-594d may be positioned on each flat side of the torsion block 592. Exemplary torsion biasing members 594a-594d may be hard rubber cylinders or similar dense, elongated elastomeric bumpers arranged about and along the walls of the torsion block 592.

The torsion biasing members 594a-594d may be held in place by a torsion case 584 formed as a steel tube of square cross section surrounding the torsion biasing members 594a-594d and the torsion block 592. The walls of the torsion case 584 may be parallel to the walls of the torsion block 592. In one implementation, the torsion case 584 make be formed by two pieces of angle steel with pieces of flat steel welded to the long edges of the angle steel to form flanges 586. The flanges 586 may form an angle of 270° with the outer walls of the torsion case 584. Opposing flanges 586 along each edge of the angle steel may be placed flush against each other. Two or more through holes may be bored in each piece of flange 586 with opposing through holes aligned with each other. Corresponding case fasteners 588, e.g., steel bolts, may be placed through the through holes to hold the two halve of the torsion case 584 together. The torsion case 584 thus holds the torsion biasing members 594a-594d tightly, but without significant compression, against the walls of the torsion block 592. The square cross-section perimeter of the torsion case 584 formed by the walls of angle steel is this larger than the square perimeter of the torsion block 592 and the torsion case 584 thus fits concentrically about the torsion block 592.

The arrangement of the torsion case 584, biasing members 594a-594d, and torsion block 592 may permit relative movement between the torsion case 584 and the torsion block 592 about an axis r, as shown in FIG. 9. For example, the torsion block 592 may be fixed to the torsion frame 523 and define the axis r. The biasing members 594a-594d may be arranged about the torsion block 592 and the axis r. The torsion case 584 may be clamped around the biasing members 594a-59d, as described herein. The torsion case 584 may be clamped around the biasing members 594a-594d such that the torsion case 584 and the torsion block 592 may rotate relative to one another about the axis r in response to a force input. The biasing members 594a-594d may impede or prevent such relative rotation based, in part, on the elastic characteristics of the biasing members 594a-594d. In this regard, the torsion axle 580 may provide damping or flexibility in the system between the parallel linkage 520 and the actuator 540. For example, and as described below, the biasing device 540 may be connected to the torsion case 584 and exert a force on the parallel closer via the torsion axle 580. The relative movement of the torsion case 584 and the torsion block 592 permitted by the biasing members 594a-594d may allow for variation in force received at the parallel linkage 520 (e.g., due to an abrupt grade change, field debris, or the like) to be absorbed at least partially by the torsion axle 580 (and biasing members 594a-594d) as opposed to encountering rigid resistance at the shaft 544 of the biasing device 540.

In other embodiments the torsion axle may be formed as a torsion spring around a shaft. However, for applications in an agricultural planter 70, such construction may not be adequately robust to withstand the jarring forces as the furrow closer assembly travels across the field.

As shown in FIGS. 6A-6E, a coupler plate 582 extends from the rear side of the torsion case 584. The coupler plate 582 may be a piece of flat steel oriented vertically and welded to angle steel on the rear side of the torsion case 584 of the torsion axle 580. A through hole may be bored through the coupler plate 582. As shown in FIGS. 6B-6D, the distal end of the shaft 544 of the biasing device 540 may be formed as a yoke 546 with a channel defined therein to define an arm on either side of the channel. Through holes may be bored in each arm of the yoke 546 transverse to the channel. The coupler plate 582 is aligned as a knife with the channel and the through holes in each of the arms of the yoke 546 align with the hole in the coupler plate 582. A coupler pin 548 extends through the through holes of each of the yoke 546 and the coupler plate 582 to pivotably connect the torsion axle 580 to the shaft 544 of the biasing device 540. The coupler pin 549 is thus connected in double shear between the yoke 546 and the coupler plate 582.

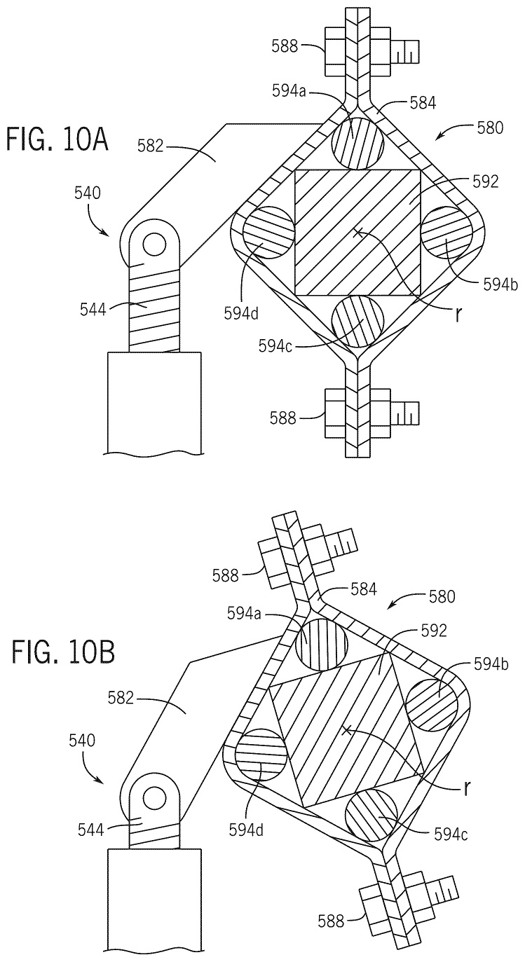

The torsion axle 580 is designed to be stiff enough to resist the exertion or retraction force of the shaft 544 of the biasing device 540 within desired parameters. For example, if it the typical range of downward force applied or upward impact force encountered is up to 50 pounds, the torsion axle 580 can be designed (e.g., by selection of materials for torsion bumpers or biasing members 594a-594d of elastic modulus) such that the torsion axle 580 remains substantially static until an impact or pull of greater than 50 pounds of force is exerted. For example, and with reference to the cross-sectional view of FIG. 10A, the torsion axle 580 may be configured to remain static for up to 50 pounds of force exerted on the parallel linkage 520. If the furrow closer assembly 500 impacts a hard surface or is otherwise subjected to a significant opposing force, the torsion axle 580 will absorb the excess force (up to 200 pounds in an exemplary embodiment) and provide additional travel for the biasing device 540 as the torsion axle 580 twists under the load, thereby preventing damage to the biasing device 540. For example, and with continued reference to FIG. 10A, the torsion block 592 and the torsion case 584 may twist or rotate about the axis r relative to one another under the additional load. The torsion block 592 and the torsion case 584 may twist in this regard with the shaft 544 remaining at a generally constant length. As such, the torsions axle 580 absorbs the additional load rather than shaft 544, which may help prevent damage to the biasing device 540.

When the biasing devices 540 on the furrow closer assembly 500 are not operating (e.g., when the planter 70 is merely in transport or is transitioning between terraces or traveling through drainages or culverts or swales between rows), the torsion axle 580 provides a safety bias to absorb the impact of jolts and jars on the furrow closer assembly 500. An upward force on the furrow closer assembly 500 translated to the biasing device 540 via the closer frame 510 impacts the coupler plate 582 through the shaft 544. The coupler plate 582 translates the force to the torsion case 584 which rotates against the torsion bumpers or biasing members 594a-594d and compresses them against the stationary torsion block 592 to absorb the force. The rotation of the torsion case 584 also allows for a small amount of travel for the biasing device 540, which further helps prevent damage. The torsion bumpers or biasing members 594a-594d then decompress and return the torsion case 584 to its original position. The torsion axle 580 can thus help prevent damage to the biasing device 540 when they are in static positions not under control of the controls system. In one example, the torsion case 584 is a closed case such that each end is closed to prevent water and debris from entering into the torsion case 584 and contacting the torsion bumpers 594a-594d and the torsion block 592. In at least one example, the torsion axle 580 can include an endcap 581 to prevent the torsion bumpers 594a-594d from working outward from the torsion case 584 and to prevent water and debris from entering into the torsion case 584 during use. The endcap 581 is illustrated in dotted lines to indicate transparency for purposed of illustration of the torsion bumpers 594a-594d and torsion block 592 disposed within the torsion case 584. In at least one example, the endcap 581 can be removed to service components within the torsion case 584.

It will be appreciated that the torsion axle 580 may provide flexibility and damping for the biasing device 540 for a range of linear extensions of the shaft 544. For example, and with reference to FIG. 10B, the biasing device 540 is shown with the shaft 544 in a retracted position as compared to the arrangement of FIG. 10A. The torsion axle 580 may be rotated, as a unit, about the axis r, as a result of the retracted position of the shaft 544. Substantially analogous to the example as described with respect to FIG. 10B, the torsion axle 580 may twist or rotate about the axis r relative to one another under the additional load. This may impart damping or flexibility into the system that may reduce the potential for damage to the biasing device 540.

Additionally, the torsion axle 580 can provide a safety release for the biasing device 540 when operational, for example, if the closer wheels 560a, 560b or other attached implements encounter an unforeseen obstacle (e.g., a rock or extremely hard soil) and imparts a significant force in an instant before any feedback can recognize the impact and can adjust. Further, the torsion axle 580 may allow the user of the agricultural planter 70 to operate the furrow closer assembly 500 without operational control of the biasing device 540 without removing and replacing the furrow closer assembly 500. For example, if the user wants to drive the tractor 50 at a greater speed than a response speed of the biasing device 540, then the biasing device 540 can be placed in an extended position to place the closing wheels 560a, 560b against the furrows 402 for closing. If the furrow closer assembly 500 encounters an obstacle or impact, the torsion axle 580 can absorb the force and prevent damage to the biasing devices 540.

With reference to FIGS. 6A-10B, the torsion axle 580 may generally be fixed relative to the parallel linkage 520. For example, the torsion block 592 may be fixed to the parallel linkage 520 at the cross-brace plate 522, as described above. In this regard, a preload or threshold load applied to the parallel linkage, such as a load applied when the biasing device 540 is inactive, may generally be set by the defined relative positions of the torsion axle 580 and the parallel linkage 520. In other examples, one or more brackets, coupling assemblies, and/or other features may be provided to permit a parallel linkage to be preloaded with a threshold load when an associated actuator is inactive. This may allow rotatable implements associated with the parallel linkage 520 to have a baseline downforce during times when the actuator is inactive. The actuator may then be operated to provide an additional load beyond the threshold load, as may be required for a given application.

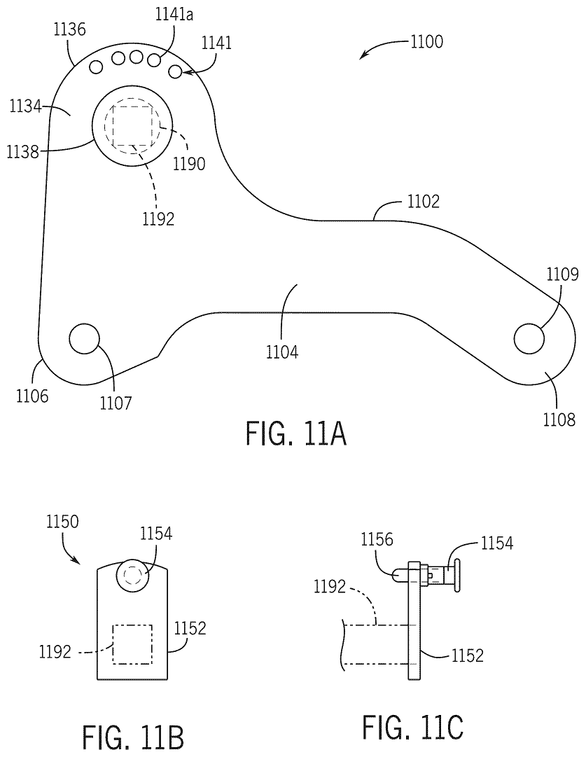

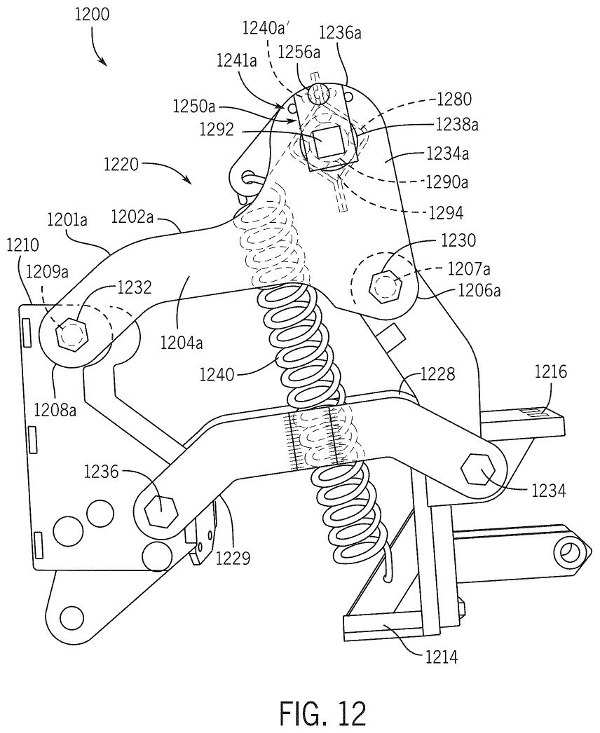

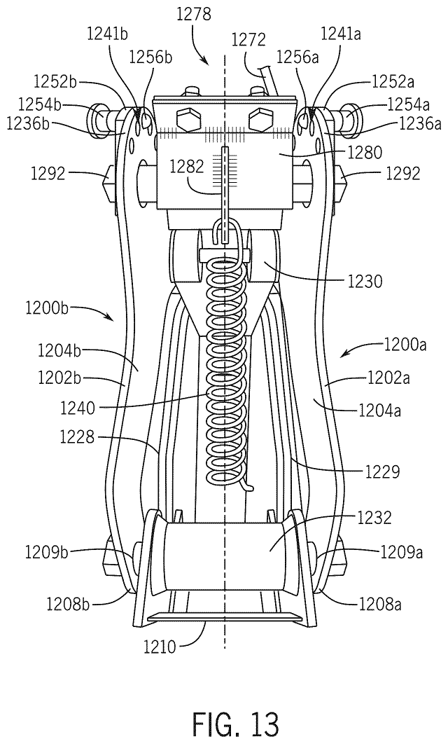

To illustrate the foregoing, FIGS. 11A-13 depict example implementations of an assembly for an agricultural planter in which a parallel linkage may be preloaded in order to induce a baseline downforce on associated rotatable implements. A sample assembly may utilize a linkage 1100, as shown in FIG. 11A. The linkage 1100 may be a linkage of a four bar linkage, such as any of the four bar linkages described herein. As described below with reference to FIGS. 12 and 13, the linkage 1100, in particular implementations, may be used in place of either (or both) of the linking bars at a top of the four bar linkage (relative to a ground surface) in a manner substantially analogous to the linking bars 526, 527 described above in relation to FIGS. 6A-6E.

In the example of FIG. 11A, the linkage 1100 is shown as including a linkage body 1102. The linkage body 1102 may be a continuous, integrally formed, and/or otherwise single sheet of metal material. In other cases, the linkage body 1102 may be a multicomponent structure. The linkage body 1102 generally includes a bar region 1104 that extends between a bar region first end 1106 and a bar region second end 1108. A first bearing hole 1107 may be defined at the first end 1106. A second bearing hole 1109 may be defined at the second end 1108. The first bearing hole 1107 and the second bearing hole 1109 may be configured for coupling the linkage 1100 with a frame or other component of the four bar linkage, such as via a bearing, bushing, and/or other component or subassembly. The bar region 1104 may generally define a link or linkage between the frames and/or other components of the four bar linkage coupled via the linkage 1100.

The linkage body 1102 may further include a mounting region 1134. The mounting region 1134 may generally extend integrally from the bar region 1104. In other examples, the mounting region 1134 may be welded, fastened, and/or otherwise secured to the bar region 1104. The mounting region 1134 may be configured to facilitate selectively defining a position of a torsion axle relative to a parallel linkage. For example, the mounting region 1134 is shown in FIG. 11A as defining a mounting region hole 1138. The mounting region hole 1138 may be a through portion of the linkage body 1102 that is configured to receive a rotatable coupling 1190 (e.g., a bearing, a bushing, and/or like assembly) and a torsion block 1192 of a sample torsion axle, such as any of the torsion axles described herein. As described in greater detail with respect to FIGS. 12 and 13, the torsion block 1192 may be rotatable relative to the linkage 1100 via the rotatable coupling 1190.

The mounting region 1134 is further shown in FIG. 11A as including a mounting region end 1136. The mounting region end 1136 may define a plurality of engagement features 1141, including sample engagement feature 1141a. The plurality of engagement features 1141 may be through portions of the linkage body 1102 that are disposed about the mounting region hole 1138. In some cases, the plurality of engagement features 1141 may be circumferentially spaced about the mounting region hole 1138 or otherwise form an arc-type path about the mounting region hole 1138. The engagement features 1141 may be configured to selectively receive a pin or other stop feature of a locator assembly that is connected to the torsion block 1192.

With reference to FIGS. 11B and 11C, a locator assembly 1150 is shown according to implementations of the present disclosure. The locator assembly 1150 may generally be configured to selectively define a position of a sample torsion axle relative to the linkage 1100. To facilitate the foregoing, the locator assembly 1150 is shown as including a locator assembly plate 1152 and a spring-biased locator pin 1154. The locator assembly plate 1152 may be configured to fixedly attach to an end of the torsion block 1192. For example, an end of the torsion block 1192 may be welded to the locator assembly plate 1152. The spring-biased locator pin 1154 may generally be housed, supported, or otherwise integrated with the locator assembly plate 1152. The spring-biased locator pin 1154 may be positioned on the locator assembly plate 1152 generally at an opposing end relative to the torsion block 1192. The spring-biased locator pin 1154 may be integrated with (e.g., extending through) the locator assembly plate 1152 such that a pin end 1156 of the spring-biased locator pin 1154 protrudes from the locator assembly plate 1152 generally along a direction of the torsion block 1192. The spring-biased locator pin 1154 may operate to selectively retract the pin end 1156, for example, by pulling the spring-biased locator pin 1154 away from the torsion block 1192. An internal spring biasing mechanism (e.g., a helical spring, a leaf spring, or the like) may operate to return the pin end 1156 to the protruding configuration shown in FIG. 11C when the spring-biased locator pin 1154 is released from said pulling or any other force that otherwise maintains the pin end 1156 away from the torsion axle.

FIGS. 12 and 13 depict an example assembly 1200. The assembly 1200 includes a parallel linkage 1220 that implements one or more linkages and/or locator assemblies, such as the linkage 1100 and locator assembly 1150 described above in relation to FIGS. 11A-11C. The assembly 1200 may generally be substantially analogous to the assembly 500 described above in relation to FIGS. 6A-10B. The assembly 1200 may thus include, among other components, a frame 1210, a mounting bracket 1216, a mounting pillar 1218, a parallel linkage 1220, a third linking bar 1228, a fourth linkage bar 1229, a first pivot bearing 1230, a second pivot bearing 1232, a third pivot bearing 1234, a fourth pivot bearing 1236, a biasing device 1240 in the form of a coil spring, a shaft 1244, a wire bundle 1242, a load cell 1270, a torsion axle 1280, a coupler plate 1282, a torsion block 1292, and torsion biasing members 1294; redundant explanation of which is omitted here for clarity. The coil spring biasing device 1240 is shown but other embodiments can include pneumatic, hydraulic, or linear screw actuator biasing devices 1240, as shown and described above with reference to other figures and embodiments.

Notwithstanding the foregoing similarities, the parallel linkage 1220 of the assembly 1200 may include a first linking bar 1201a and a second linking bar 1201b. The first linking bar 1201a may be substantially analogous to the linkage 1100 of FIG. 11A and include, among other components: a linkage body 1202a, a bar region 1204a, a bar region first end 1206a, a first bearing hole 1207a, a bar region second end 1208a, a second bearing hole 1209a, a mounting region 1234a, a mounting region end 1236a, a mounting region hole 1238a, a plurality of engagement features 1241, and an example engagement feature 1241a′; redundant explanation of which is omitted here for clarity. Shown in FIGS. 12 and 13, the first linking bar 1201a may be associated with a first locator assembly 1250a, which may be substantially analogous to the locator assembly 1150 of FIGS. 11B and 11C, and include: a locator assembly plate 1252a, a spring-biased locator pin 1254a, and a pin end 1256a; redundant explanation of which is omitted here for clarity. The second linking bar 1201b may also be substantially analogous to the linkage 1100 of FIG. 11A and include, among other components: a linkage body 1202b, a bar region 1204b, a bar region first end 1206b, a first bearing hole 1207b, a bar region second end 1208b, a second bearing hole 1209b, a mounting region 1234b, a mounting region end 1236b, a mounting region hole 1238b, a plurality of engagement features 1241b, and an example engagement feature 1241b′; redundant explanation of which is omitted here for clarity. Further, shown in FIGS. 12 and 13, the second linking bar 1201a may be associated with a second locator assembly 1250b, which may be substantially analogous to the locator assembly 1150 of FIGS. 11B and 11C, and include: a locator assembly plate 1252b, a spring-biased locator pin 1254b, and a pin end 1256b; redundant explanation of which is omitted here for clarity.

The assembly 1200 may be coupled in a manner substantially analogous to that as described in relation to the assembly 500 of FIGS. 6A-6E. For example, the first linking bar 1201a may be pivotally coupled to the mounting bracket 1216 at the first bearing hole 1207a using the first pivot bearing 1230. The first linking bar 1201a may further be pivotally coupled to the frame 1210 at the second bearing hole 1209a using the second pivot bearing 1232. Further, second linking bar 1201b may be pivotally coupled to the mounting bracket 1216 at the first bearing hole 1207b using the first pivot bearing 1230. The second linking bar 1201b may be pivotally coupled to the frame 1210 at the second bearing hole 1209b using the second pivot bearing 1232. Further, the third linking bar 1228 may be pivotally coupled to the mounting bracket 1216 using the third pivot bearing 1234. The third linking bar 1228 may be further pivotally coupled to the frame 1210 using the fourth pivot bearing 1236. Further, the fourth linking bar 1229 may be pivotally coupled to the mounting bracket 1216 using the first pivot bearing 1234. The fourth linking bar 1229 may be pivotally coupled to the frame 1210 using the fourth pivot bearing 1236.

The first linking bar 1201a and the second linking bar 1201b may be coupled with the torsion axle 1280. For example, a first rotatable coupling 1290a may be arranged within the mounting region hole 1238a. The first rotatable coupling 1290a may be a bearing including an outer race generally fixed to the first linking bar 1201a in the mounting region hole 1238a, and an inner race that is rotatable relative to the outer race. Further, a second rotatable coupling 1290b may arranged with the mounting region hole 1283b. The second rotatable coupling 1290b may also be a bearing including an outer race generally fixed to the second linking bar 1201b in the mounting region hole 1238b, and an inner race that is rotatable relative to the inner race. In the implementation of FIGS. 12 and 13, the assembly 1200 may be further coupled with the torsion block 1252 pivotally coupled to the first linking bar 1201a and the second linking bar 1201b via the respective first and second rotatable couplings 1290a, 1290b. For example, the torsion block 1292 may extend through, and be fixed connected to, the inner race of each of the respective first and second rotatable couplings 1290a, 1290b. Accordingly, the torsion block 1292 (and thus too the associated components of the torsion axle 1280) may rotate relative to each of the first and second linking bars 1201a, 1201b.

For purposes of illustration, the first locator assembly 1250a, the second locator assembly 1250b, and the torsion axle 1280 may collectively define a coupling assembly 1278. The coupling assembly 1278 may be used to selectively load the parallel linkage 1220 with a threshold or preload force by defining a rotational position of the torsion block 1292 (and associated biasing device 1240) relative to the parallel linkage 1220. For example, the linkage 1200 may be further coupled in a manner that allows the rotational position of the torsion axle 1280 to be selectively defined with respect to the first and second linking bars 1201a, 1201b. For example, and as shown in FIGS. 12 and 13, the locator assembly plate 1252a of the first locator assembly 1250a may be fixed at a first end of the torsion block 1292 that protrudes from the inner race of the first rotatable coupling 1290a. Further, the locator assembly plate 1252b of the second locator assembly 1250b may be fixed at a second end of the torsion block 1292 that protrudes from the second rotatable coupling 1290b. In some cases, a terminal face of the torsion block 1292 may be welded to the respective plates 1252a, 1252b. In other examples, the respective plates 1252a, 1252b may define a through portion for receiving the ends of the torsion block 1292, and the torsion block 1292 is welded to the plates 1252a, 1252b about the aperture.

The coupling of the first locator assembly 1250a to the torsion block 1292 may generally arrange the first locator assembly 1250a adjacent the mounting region 1234a. The first locator assembly 1250a may be arranged adjacent the mounting region 1234a such that the spring-biased locator pin 1254a is arranged along an arc or path defined by the plurality of engagement features 1241a such that the pin end 1256a may be selectively received in any given one of the engagement features 1241a. Further, the coupling of the second locator assembly 1250b to the torsion block 1292 may generally arrange the second locator assembly 1250b adjacent the mounting region 1234b. The second locator assembly 1250b may be arranged adjacent the mounting region 1234b such that the spring-biased locator pin 1254b is arranged along an arc or path defined by the plurality of engagement features 1241b such that the pin end 1256b may be selectively received in any given one of the engagement features 1241b.

Although various representative embodiments of agricultural planters have been described herein with a certain degree of particularity, those skilled in the art could make numerous alterations to the disclosed embodiments without departing from the scope of the inventive subject matter set forth in the specification and claims. The various embodiments discussed herein are not exclusive to their own individual disclosures. Each of the various embodiments may be combined with or excluded from other embodiments. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the example embodiments described herein, and are not limiting, particularly as to the position, orientation, or use of the inventive concepts unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other unless specifically stated.

In some instances, components are described with reference to “ends” having a particular characteristic and/or being connected with another part. However, those skilled in the art will recognize that the components described are not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. An assembly for an agricultural planter, comprising:
a mounting bracket configured for attachment to a frame of the agricultural planter;
an implements frame configured for mounting rotatable implements of the agricultural planter;
a parallel linkage pivotally connecting the mounting bracket to the implements frame; and
a biasing device having a first end and a second end, the first end associated with the mounting bracket, and the second end associated with the parallel linkage such that the biasing device selectively loads the rotatable implements with a threshold load,
wherein the biasing device is configured to manipulate the parallel linkage and load the rotatable implements with additional load in excess of the threshold load.

2. The assembly of claim 1, wherein:
the assembly further comprises a coupling assembly connecting the second end of the biasing device to the parallel linkage; and
the coupling assembly is configured to selectively define a position of the second end of the biasing device relative to the parallel linkage.

3. The assembly of claim 2, wherein:
in a first configuration, the coupling assembly is configured to define a first position of the second end of the biasing device relative to the parallel linkage;
the first position of the second end of the biasing device relative to the parallel linkage establishes the threshold load as having a first value;
in a second configuration, the coupling assembly is configured to define a second position of the second end of the biasing device relative to the parallel linkage; and
the second position of the second end of the biasing device relative to the parallel linkage establishes the threshold load as having a second value that is different than the first value.

4. The assembly of claim 3, wherein:
the biasing device comprises a shaft;
the shaft is associated with one of the first end or the second end; and
the shaft is extendable to cause the biasing device to load the rotatable implements with the additional load in excess of the threshold load.

5. The assembly of claim 4, wherein:
the coupling assembly further comprises a torsion axle;
the shaft is associated with the second end and pivotally attached to the torsion axle; and
the coupling assembly is configured to selectively define a rotational position of the torsion axle relative to the parallel linkage, thereby selectively defining the position of the second end of the biasing device relative to the parallel linkage.

6. The assembly of claim 5, wherein:
the coupling assembly further comprises a locator assembly fixed to the torsion axle and having a locator pin; and
the locator pin is manipulatable between,
an extended position in which the locator pin is engaged with the parallel linkage and restrain a rotation of the torsion axle relative to the parallel linkage, and
a retracted position in which the locator pin is disengaged with the parallel linkage and permits the rotation of the torsion axle relative to the parallel linkage.

7. The assembly of claim 4, wherein:
the biasing device comprises a linear screw actuator; and
the shaft comprises a lead screw.

8. The assembly of claim 4, wherein:
the biasing device comprises a pneumatic or hydraulic cylinder assembly including a first cylinder and a second cylinder extending from the first cylinder; and
the shaft comprises the second cylinder.

9. The assembly of claim 1, wherein:
the parallel linkage comprises a four bar linkage;
two upper bars of the four bar linkage are both attached to a first pivot bearing at first ends and are both attached to a second pivot bearing at second ends; and
two lower bars of the four bar linkage are both attached to the mounting bracket at a third pivot bearing at the first ends and are both attached to a rigid frame at a fourth pivot bearing at the second ends.

10. An assembly for an agricultural planter, comprising:
a mounting bracket configured for attachment to a frame of the agricultural planter;
an implements frame configured for mounting rotatable implements of the agricultural planter;
a parallel linkage pivotally connecting the mounting bracket to the implements frame, the parallel linkage comprises an upper bar having a mounting region with a plurality of engagement features; and
a biasing device having a first end and a second end, the first end associated with the mounting bracket, and the second end associated with an engagement feature of the plurality of engagement features.

11. The assembly of claim 10, wherein the upper bar further includes a bar region extending integrally from the mounting region and pivotally connecting the mounting bracket to the implements frame with a first pivot bearing connecting the mounting bracket to the bar region and a second pivot bearing connecting the bar region to the implements frame.

12. The assembly of claim 11, wherein the bar region and the mounting region are regions of a common plate.

13. The assembly of claim 10, wherein:
the assembly further comprises a coupling assembly connecting the second end of the biasing device to the parallel linkage; and
the coupling assembly is configured to selectively define a position of the second end of the actuator relative to one or more of the plurality of engagement features.

14. The assembly of claim 13, wherein:
the actuator is configured to load the rotatable implements with a first threshold load when the coupling assembly selectively defines the position of the second end of the biasing device relative to the engagement feature; and
the biasing device is configured to load the rotatable implements with a second threshold load when the coupling assembly selectively defines the position of the second end of the biasing device relative to a second engagement feature of the plurality of engagement features.

15. The assembly of claim 14, wherein the actuator comprises a linear screw actuator configured to manipulate the parallel linkage and load the rotatable implements with additional load in excess of the first or second threshold loads.

16. The assembly of claim 14, wherein:
the mounting region is defined by a portion of a metal plate;
the plurality of engagement features comprises a plurality of holes extending through the portion of the metal plate; and
the coupling assembly comprises a locator assembly configured to selectively engage holes of the plurality of holes such that the locator assembly selectively defines the position of the second end of the biasing device relative to the parallel linkage.

17. The assembly of claim 16, wherein:
the coupling assembly further comprises a torsion axle rotatably coupled to and extending through the metal plate, the second end of the biasing device pivotally coupled to the torsion axle; and
the locator assembly is fixed to the torsion axle and comprises a spring-biased locator pin configured for selective receipt into the holes of the plurality of holes.

18. A method of operating a planter assembly comprising a parallel linkage attached between rotatable implements and a frame of an agricultural planter, and a biasing device fixedly mounted to the frame and pivotably mounted to the parallel linkage, wherein the method comprises:
loading the rotatable implements with a threshold load by selectively setting a position of the biasing device relative to the parallel linkage; and
loading the rotatable implements with additional load in excess of the threshold load by actuating the biasing device and extending a shaft of the biasing device.

19. The method of claim 18, wherein:
the position is a first position and the threshold load is a first threshold load;
the method further comprises loading the rotatable implements of the planter assembly with a second threshold load by selectively setting a second position of the biasing device relative to the parallel linkage; and
the additional load is in excess of the first and second threshold loads.

20. The method of claim 18, wherein loading the rotatable implements of the planter assembly with the threshold load further comprises operating a locator pin to selectively set the position of the biasing device relative to the parallel linkage.
